(19) United States
(12) Patent Application Publication
(10) Pub. No.: US 2013/0233919 A1
(43) Pub. Date: Sep. 12, 2013

(54) Systematic Monitoring of Food Products

(71) Applicant: TTRC, TRAINING, TRADING & CONSULTANCY B.V., Tuil (NL)

(72) Inventor: Frans U. A. van Waes, Tuil (NL)

(73) Assignee: TTRC, Training, Trading & Consultancy B.V., Tuil (NL)

(21) Appl. No.: 13/867,667

(22) Filed: Apr. 22, 2013

Related U.S. Application Data
(63) Continuation of application No. PCT/NL2011/050697, filed on Oct. 12, 2011.

(30) Foreign Application Priority Data
Oct. 21, 2010 (NL) 2005557

(51) Int. Cl. G06F 17/30; B42D 15/00; G06K 19/06

(52) U.S. Cl. CPC G06F 17/30979; G06K 19/06028; G06K 19/06037; B42D 15/00
USPC 235/375; 235/494; 283/81; 283/67; 206/389

(57) ABSTRACT

Detachable printed image for track and trace purpose of a product, comprising a first and a second part, the first and second part both having the same single unique number for single use, the first and second part being separable from each other, wherein optionally the first and or second part comprises one or more of a colour code, a figure, a first text item, and a second text item, for recording product information and/or wherein optionally a tear line is present between said first and second part.

### CROSS REFERENCE TO RELATED APPLICATIONS

This Application is a continuation application of the International Patent Application with Ser. No. PCT/NL2011/050697, entitled “Systematic Monitoring of Food Products”, to TTRC Training, Trading & Consultancy B.V. Tuil, The Netherlands, filed on Oct. 12, 2011, which claims the priority of Netherlands application, Serial No. NL 2005557, filed on Oct. 21, 2010, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHT MATERIAL

Not Applicable.

1. Field of the Invention

The present invention is in the field of systematic monitoring of food products.

2. Description of Related Art

Hazard Analysis Critical Control Point (HACCP) is a systematic preventive approach to food safety and pharmaceutical safety that addresses physical, chemical, and biological hazards as a means of prevention rather than finished product inspection. HACCP is used in the food industry to identify potential food safety hazards, so that key actions, known as Critical Control Points (CCPs) can be taken to reduce or eliminate the risk of the hazards being realized. The system is used at all stages of food production and preparation processes including packaging, distribution, etc. The use of HACCP is currently partly voluntary.

HACCP has been recognized internationally as a logical tool for adapting traditional inspection methods to a modern, science-based, food safety system. Based on risk-assessment, HACCP plans allow both industry and government to allocate their resources efficiently in establishing and auditing safe food production practices. In 1994, the organization of International HACCP Alliance was established initially for the US meat and poultry industries to assist them with implementing HACCP and now its membership has been spread over other professional/industrial areas.

Hence, HACCP has been increasingly applied to industries other than food, such as cosmetics and pharmaceuticals.

HACCP was initially set on three principles. By 1997 the seven HACCP principles listed below became the standard.

The HACCP seven principles are Conduct a hazard analysis; Identify critical control points; Establish critical limits for each critical control point; Establish critical control point monitoring requirements; Establish corrective actions; Establish record keeping procedures; and Establish procedures for ensuring the HACCP system is working as intended.

The seven HACCP principles are included in the international system ISO 22000. This standard is a complete food safety management system incorporating the elements of prerequisite programs for food safety, HACCP and quality management system which together form an organization's Total Quality Management.

A Data Matrix code typically is a two-dimensional matrix barcode consisting of black and white “cells” or modules arranged in either a square or rectangular pattern. The information to be encoded can be text or raw data. Usual data size is from a few bytes up to 2 kilobytes. The length of the encoded data depends on the symbol dimension used. Error correction codes are added to increase symbol strength: even if they are partially damaged, they can still be read. A Data Matrix symbol can store up to 2,335 alphanumeric characters.

Data Matrix symbols are typically rectangular in shape and usually square, they are made of cells: little elements that represent bits. Depending on the situation a “light” module is a 0 and a “dark” module is a 1, or vice versa. Every Data Matrix is composed of two solid adjacent borders in an “L” shape (called the “finder pattern”) and two other borders consisting of alternating dark and light “cells” or modules (called the “timing pattern”). Within these borders are rows and columns of cells encoding information. The finder pattern is used to locate and orient the symbol while the timing pattern provides a count of the number of rows and columns in the symbol. As more data is encoded in the symbol, the number of cells (rows and columns) increases. Symbol sizes vary from 8×8 to 144×144.

The most popular application for Data Matrix is marking small items, due to the code's ability to encode fifty characters in a symbol that is readable at 2 or 3 mm² and the fact that the code can be read with only a 20% contrast ratio. The Data Matrix is scalable, with commercial applications as small as 300 micrometers (laser etched on a 600 micrometer silicon device) and as large as a 1 meter (3 ft) square (painted on the roof of a boxcar). Fidelity of the marking and reading systems are the only limitation.

Data Matrix codes are part of a new traceability drive in many industries, particularly aerospace where quality control is tight and a black market exists for counterfeit or non-serviceable parts. Data Matrix codes (and accompanying alpha-numeric data) identify details of the component, including manufacturer ID, part number and a serial number.

The Data Matrix format is used by Semacode to encode 4096 bits RSA private keys that can be read by cameras or scanners.

A data matrix on a Mini PCI card, encoding the serial number Data Matrix codes is becoming common on printed media such as labels and letters. The code can be read quickly by a scanner which allows the media to be tracked, for example when a parcel has been dispatched to the recipient.

For industrial engineering purposes, Data Matrix codes can be marked directly onto components, ensuring that only the intended component is identified with the Data Matrix encoded data. The codes can be marked onto components with various methods, but within the aerospace industry these are commonly industrial ink-jet, dot-peen marking, laser marking, and electrolytic chemical etching (ECE). These methods give a permanent mark which should last the lifetime of the component.

After creation of the Data Matrix code, the code is usually verified using specialist camera equipment and software. This verification ensures the code conforms to the relevant standards, and ensures it will be readable for the lifetime of the component. After the component enters service, the Data Matrix code can then be read by a reader camera, which decodes the Data Matrix data which can then be used for a number of purposes, such as movement tracking or inventory stock checks.

Data Matrix codes, along with other Open Source codes such as 1D Barcodes can also now be read with mobile phones, simply by downloading the application to compatible mobile phones. Although the majority of these mobile readers are capable of reading Data Matrix, only a few can extend the decoding to enable mobile access and interaction, whereupon the codes can be used securely and across media; for example, in track and trace, anti-counterfeit, e.govt, and banking solutions.

Various standards for Data Matrix exist, which can be applied when relevant.

Semacodes are primarily aimed at being used with cellular phones which have built-in cameras, to quickly capture a Web site address for use in the phone's web browser. Semacodes are in fact Data Matrix encoded URLs.

Potential uses for Semacode tags are still being explored, and will complement development of the concept of using mobile phones as devices for information gathering and exchange. Typically these relate to linkage to a website, setting of preferences, background info, etc.

However, such applications are limited to a single contact.

Many applications are further not very reliable, or not reliable enough.

Also, many applications are not real time available. Such is for instance required by various control protocols, such as ISO or HACCP.

Even further the above applications are cumbersome to use. Therefore a lot of discipline is needed to maintain or even reach standards, such has the HACCP standard. Also it is very easy to make mistakes, to have an incomplete log of data, and it is relatively difficult to have a log permanently accessible, during production, and in many ways such is also not practical at all. Even further, it is quite typical to use labels and then write information on the labels using a pen or the like. In those cases information easily gets lost, as ink is washed away at some point in time.

It is known in the prior art to provide labels: for example as recited in German patent application numbers DE 299 06 832 U1 and DE 94 10 708 U1.

German patent number DE 299 06 832 U1 recites a self-adhesive label for labelling of vessels for the inclusion of materials, in particular blood or urine samples, wherein the label is composed of a first label part permanently bondable with the vessel as well as a second label part detachable along a mechanically weakened line and the first and second label parts are providable with an identifier.

German patent number DE 94 10 708 U1 recites a label roll with self-adhesive labels arranged in a plurality of rows on a common backing wherein each label is composed of a head label as well as an additional label separable along a mechanically weakened line and each head label and additional label are provided with each other's assigned identifier.

Labels of the prior art are not suitable for HACCP applications: for example, they are not hygienic; furthermore the usual practice of printing the labels “on-the-spot” is problematic since this can lead to cross-contamination, for example with bacteria such as salmonella. There remains a need for an improved track and trace system, especially one being applicable in relative chaotic situations such as a kitchen of a restaurant and the like. Even further there is a need for a system being relatively simple in use. Also there is a need for a system which requires a minimum effort to maintain, to update, and to develop, as well which is cheap to use.

### BRIEF SUMMARY OF THE INVENTION

In a first aspect the present invention relates to a detachable printed image for track and trace purpose of a product, suitable for HACCP, comprising a first and a second part, the first and second part both having the same single unique number for single use, the first and second part being separable from each other, wherein optionally the first and or second part comprises one or more of a color code, a figure, a first text item, and a second text item, for recording product information, a reel comprising said images, a track and trace method using said image, an application, and use of the image.

The present invention overcomes one or more of the above problems and/or disadvantages and provides advantages as mentioned below.

The image relates to a 2-dimensional object.

The image is detachable, as for instance on an adhesive tape, forming part thereof, on a label, and the like. Therefore the image does not relate to, for instance, a copy or print of an image on a plane sheet of paper.

The image is printed. This is an important feature, as by printing a person interested in applying images for track and trace purpose can directly make use of the image, without having to add further information for instance. Printing also allows for images to have consecutive numbers. Such seems rather trivial, but until now printing detachable images having consecutive numbers is quite complicated, e.g. in that digital memory and processing speed are limiting factors. The image is preferably printed in advance, i.e., not “on-the-spot”.

The image comprises various distinguishable elements. The image may be in full color, or in black and white.

The image comprises a first part and a second part, both parts comprising elements, which elements may in principle be the same or be different. However, the first and the second part comprise a unique number, which number is the same for both parts. Even further, the number is unique, that is in principle only one single such number exists. Such is for instance different for a serial number, which serial number is identical for all products in a series. The number is for single use, and as a consequence any product will be numbered different compared to any other product.

The first and second parts are separable. Thereby a first part can for instance be used to be attached to the product, and a second part to be attached to for instance a logbook, or vice versa. It is noted that the first and second part need not be separated, the option however exists. In an example a tear line is provided between the first and second part, in order to support separation of the two.

### DETAILED DESRIPTION OF THE INVENTION

In an example according to the invention the number is alpha numerical . As such any combination of available characters is envisaged. The number typically consists of a large number of characters, such as 13 characters or more, typically 16 characters or more, preferably 32 characters or more, such as 40 characters or more. Clearly the number of characters limits the application of the image, and is preferably as large as possible. Further, the number of characters is limited by space available on the image.

The number can for example be built up as follows:

A first character, such as “A”, which character may reflect a day of the week.

Two further digits, reflecting a day of the month;

Two further digits reflecting the month;

Two further digits reflecting the year; optionally 4 digits;

Eight further digits; in an example starting with 0, consecutive numbered for each individual day.

A consequence of the above numbering may be that every day one starts with a 0 again. An example is “A09081000000001”.

The numbering is about avoiding the same codes, that is use every code only once. Always on making errors: miss a few codes and then start again.

On each label the same way of making codes is used: per item only one difference:

In an example Monday always starts with A, Tuesday with B, Wednesday with C, Thursday with D, Friday with E, Saturday with F, and Sunday with G. Further codes for Storage with H, fridge with I, and Freezer with J.

The present image is preferably relatively small, thereby making the image easy to handle. In an example the image has a width of from 1-3 cm, such as 2 cm, and a height of from 1-4 cm, such as 2.5 cm. A first part is in an example about 1.0 cm high, and a second part about 1.5 cm high. The data matrix is in an example as small as possible, wherein a size thereof is limited by optical resolution of a camera used, and software in the camera processing the digital image. Even though nowadays cameras have a high resolution, such resolution may be limited by software processing an image. As a consequence, the data matrix is in an example about 0.7 cm by 0.7 cm. In a further example the image has a width of from 2-6 cm, such as 4 cm, and a height of from 2-8 cm, such as 5 cm. A first part is in an example about 1.5 cm high, and a second part about 2.5 cm high. In a further example the image has a width of from 6-20 cm, such as 10 cm, and a height of from 8-25 cm, such as 16 cm. A first part is in an example about 5 cm high, and a second part about 7 cm high.

In an example according to the invention the first and/or second part comprises one or more of an optical code, a barcode, a data matrix, preferably a data matrix. A barcode and data matrix per se are well known to the person skilled in the art.

In an example according to the invention, wherein the first and/or second part comprises one or more of an optical code, a bar code and a data matrix, the optical code, bar code and/or data matrix encode at least the unique number. The optical code, bar code and/or data matrix thus contains all of the information needed to link a unique product with a database entry or the like, such as in a cloud database, relating to the unique product.

In an example according to the invention, wherein the first and or second part comprises one or more of an optical code, a bar code and a data matrix, the optical code, bar code and/or data matrix encode a uniform resource locator (URL). Upon scanning the optical code, bar code and/or data matrix, a user is directed directly to online information, such as an entry in a database, such as a cloud database. As an example a data matrix is scanned in a first step by a device such as a mobile phone connected to the internet; in a second step, the online information at the address to which the URL directs, such as an entry in a database, such as in a cloud-database, is displayed to the user. Thus encoding an URL constitutes a simple method for directing a user to information stored at a particular web address. For clarity, the term “cloud” as used in the context of a “cloud database” is intended to refer to a database, such as a publicly accessible database, provided as a service, whereby shared resources, i.e., database entries, are provided to computers and other devices, as a utility (c.f. electricity, water, gas, telephone services etc) over a network, such as the internet; data can be added to, and/or retrieved from the database by a connected user, perhaps subject to required permissions.

In an example according to the invention, the URL comprises the unique number. By incorporating the unique number in the URL, the URL is similarly unique; furthermore the URL is identifiable with the unique number.

In an example, the URL links to a preferably public accessible database, such as a cloud database, perhaps subject to required permissions, such as by subscription.

In an example, the URL has the form:

http://www.hacpdb.com/c.php?c=X, wherein X is the unique number.

In an example, information about a particular product is stored on an individual web page or group of web pages reachable using the URL, wherein the individual web page or group of web pages comprise part of a database.

In an example according to the invention the first and or second part comprises one or more of a color code, a figure, a first text item, and a second text item, for recording product information. For instance, as is also indicated in the figures, every single day of the week may have a color associated therewith. Even further, every month may have a figure associated therewith. Thereby it is very easy to recognize a production day of a product. Such indicates that a user would use on an organized manner a color for a product produced on a specific day of a week. As such, it is very easy to determine if a product as passed it shelf life, just by looking at the color of the image. Typically, also a date of production is indicated on a first and or second part of the image, for instance by a two-letter code. Even further, typically also a removal day is indicated, typically also by a two-letter code. For instance, a product produced on Thursday could be identified by a code TH, and by a further code SU, indicating the product should be removed on Sunday following the Thursday.

In an example according to the invention the image comprises an adhesive for attaching the image to the product, preferably an adhesive which is water soluble, more preferably water soluble at elevated temperature, such as at a temperature of 35° C.-90° C. As such the image can easily be removed from a product, when cleaning a container comprising the product, such as by a dish washer. In an example the adhesive is therefore soluble at elevated temperature, i.e. at a temperature at which product containers are cleaned. Such has the advantage that no adhesive remains on a product container, and as a consequence the product container van be reused. Also cross-contamination and risk thereon is limited.

In a second aspect the present invention relates to a reel comprising a plurality of images according to the invention, wherein the unique number of each images is numbered consecutive, i.e., wherein the unique number of each image of the plurality of images that the reel comprises, follow one another on the reel in uninterrupted succession so as to form a reel of consecutively numbered images.

It is in principle possible to number images consecutive. However, such numbering is very time consuming, especially if modern printing techniques are used. The reel comprises from 10-10.000 images, preferably from 50-2.000 images, such as from 100-1000 images. Depending on application of images a larger or smaller number of images is preferred. Preferably the images are provided as labels, which labels can be detached from a foil, such as a paper foil or the like. Also adhesive tape is envisaged, whereby images can for instance be separated from one and another bus tearing the tape.

Typically various reels may be provided, such as for every day a reel, and/or for every application a reel, such as for freezing, storing and for cooling.

In a third aspect the present invention relates to a box, comprising the reel according to the invention, which reel is provided in a container. The container is preferable recyclable, and is hygienic in order to prevent cross-contamination. For ease of use a box may be provided, comprising the reel, and allowing images to be separated from the reel. Preferably the box is suited for use in a food production environment, that is food safe, easy to clean, easy to maintain clean, and easy to use. In an example a series of boxes may be used, for instance for every day one box. In an example boxes may be removable attached to one and another.

In a fourth aspect the present invention relates to a method for track and trace, comprising the steps of:

a. attaching a first part of an image according to the invention on a product,

b. optionally attaching a second part of an image according to the invention in a logbook,

c. recording product information, and

d. combining product information and unique number, wherein the product preferably is a food product.

In a first step, a first part of the first part of the image is attached to a product, such as a food product, such as a product prepared in a kitchen of a restaurant. Thereby the product is uniquely and traceably labeled.

In an optional second step, the second part of the image is attached to a logbook. Thereby also an in house track and trace system is provided.

In an example the image, and first and second part thereof, are provided with an adhesive, thereby allowing the image to be attached to a product or logbook.

In a second (or optionally third) step product information, as for instance mentioned below, are recorded. Recording can take place by entering information into a mobile phone and transmitting said information to a recorder, such as a database of an on-line computer, or directly into a computer. As a less preferred example information can also be recorded in a logbook. Typically entering of data is performed manually, by entering data directly and/or selecting data in a menu or the like.

In a further step product information and unique number are combined. Such combination may happen as the image and unique number therein link to a unique record of a database, such as a cloud database.

The method is very suited for food control purposes and the like, such as within a HACCP system. It is especially suited for use in kitchens and so on, in view of the advantages mentioned.

The present method does not require much paper work. It does however provide a thorough analysis of processes and critical control points.

Using a color coding system is further advantageous, in that colors are directly visible for a user and hardly any training is required to implement such a system. The color is very indicative for an action to be performed, e.g. removing a product as it is deemed over date. The color is also multicultural.

The system can also be used in a limited version, i.e., using only basic features thereof and/or using only a limited set of parameters to be monitored.

In an example, the system can be used in a limited version to monitor medication, such as to monitor compliance with a dose regime and/or to give alerts, e.g., when medication has been forgotten. In an example, this could be achieved by providing a dose or doses such as in a blister comprising a certain number of tablets with a unique label or labels, such as the label comprised in the system of the invention, to be scanned by a patient upon taking the medication; upon scanning the image, an online database would be updated. If an expected update were not received by the system, an alert would be sent. Use of the system in such an example would be particularly advantageous for elderly patients, perhaps helping to prevent instances of hospitalization and to allow monitoring by professionals and/or insurance companies.

On the other hand, the system can also be extended quite easily, by adding parameters to be monitored for instance. As such it is also very easy to adapt to amended regulations, if applicable. Adding and/or removing parameters/data is quite easy to do.

Having information available in an on-line database, such as a cloud database, offers further advantages, especially towards future use. An almost full transparency of product history may be appreciated in many aspects, e.g. by a potential customer, a control officer, etc.

Even further, missing information can be entered with the same ease of use, thereby adding valuable information relating to a product.

The method further allows information relating to customers using/consuming the product to be added. Such is regarded valuable information for doing business.

The method relates specifically to food quality and food safety, and is as such particularly suited.

Having an on-line database, such as a cloud database, available also provides the advantage that information is virtually continuous available. Such is very practical in many cases, such as during production, and for giving alerts or push messages prompting a user to act, advise, or neglect the information.

It is also very practical to have an image that can be separated in two parts, each part having an identical and unique number. In one go a first part of the image can be attached to a product and a second part of the image can be attached to a logbook.

Of course there is always an option to use both a database and a logbook. The logbook can is such a case function as a back-up, or vice versa. So even in cases unforeseen, such as a fire, data will be retained.

The method further allows marking menus, for instance day menus.

Although the system stems from food processing, it is also very well suited for other environments, such as industrial productions environments.

It is noted that in a certain aspect the unique number functions as a key to a database, directly linking a user to a record of the database.

The method is also very suited to be extended, e.g. to a cash register, to an inventory monitoring system, etc. The method may further be used for advertising purposes.

The track and trace system is also very suited for coding of articles having a single use.

The method is especially suited if a data matrix is used. Such a matrix offers further advantages, especially in view of amount of data to be processed and/or recorded.

The present method provides a harmonized method for food safety, amongst others based on European Directives, e.g., (EG) nr. 178/2002, relating to food safety and food control. The method is very easy extendable, starting e.g. at a farmer producing e.g. a vegetable, to an end-user, such as a consumer.

In an example according to the invention the product information and unique number are entered in a database, preferably an on-line accessible database (clouding). An on-line accessible database can be entered by scanning a data matrix, which matrix automatically redirects the user to a unique field in the on-line database. Using a menu data can then be entered in the database. Also data can be entered directly. Such provides ease of use, direct and instantaneous access, track and traceability etc.

In an example according to the invention the unique number is optically scanned, preferably by a camera in a mobile phone, preferably a mobile IPHONE® 4.1 and higher. In an example a mobile phone is used. Nowadays mobile phones are abundantly available and easy to use. A user may use his own or company phone when producing a product to subsequently enter data into the database. An I-phone is used in an example as it is easy to use, may provide applications that can be implemented in the track and trace process, etc.

In an example according to the invention the product information is entered into the database using a menu, preferably using one of Apple® software for IPHONE® 4.1, Android® software, and Microsoft® 7.0 and higher software. Using a menu will direct a user through requirements of a control system.

An example according to the invention, product information is coupled to process information of the product. In an example also (standard) process information of the product may be entered, such as into the database. Such information may already have been entered at forehand, especially if the information would relate to standard processes, such as standard recipes used in a kitchen.

In an example according to the invention an alert or warning is provided in case storage life/shelf life of a food product has ended or is near to the end thereof. The database may also be provided with one or more routines which one or more routines are able to detect an end of use date of a product. Such may be relevant is for instance a sauce is prepared, which sauce is used in a food product during several days, and is stored in between use, for instance in a fridge.

In a fifth aspect the present invention relates to an application for performing the method according to the invention stored on a computer or mobile device and executable thereon comprising the steps of

scanning an image according to the invention,

transmitting said scanned image to a database, preferably by wireless transmission, e.g., WiFi,

wherein the unique code of the image is linked to a record of a database, such as an on-line database, whereby the record of the database is made available for entering data and/or reading data, and

optionally providing a menu for entering and/or reading data, such as product data, into and/or form the database.

Preferably the application relates to a drag and drop system.

In an example the architecture used relates to so-called open architecture.

Optionally access to a database requires a log-in name, optionally also a password. Such also fits perfectly in a track and track system.

An example a first step would be to start an application on a mobile phone and then follow a menu, for instance by scanning a code.

An application typically also comprises check and balances, e.g., “continue”, “accept”, “cancel” functions and the like. Such allows correcting for mistakes and/or missing items in data entered.

An example, a menu is provided whereby data can be entered, e.g., item by item. As such a user is guided through data items required.

In an example also a scroll function is provided. Such is especially suited for adding numbers, such as is familiar to I-phone and I-pad users.

In an example also an overview of data entered is provided, allowing a person to check such data.

In order to make life easy standard items are also provided, such as a standard list of recipes typically used. Thereby entering straightforward and/or double data is avoided, such as ingredients used, processing conditions, etc. Of course the list may be extended with new recipes, amended recipes, etc.

In an example also a send option is provided.

In an example also records entered can be selected. The application is considered very user friendly and has been tested in this respect extensively.

In a first step the image is scanned. Specifically the unique number and/or optical code, is/are scanned. The optical code is a data matrix in an example. The data matrix provides direction to a record of a database; this can for example be achieved by encoding an URL that links to a record of a database contained on a particular web page, said web page preferably being identifiable by the unique number. Scanning can be done by using a camera in a mobile telephone, such as an I-phone.

Next data is transmitted to the database. In an example transmission is wireless, making use of an available telephone network.

The unique code of the image is linked to a record of a database, thereby allowing access to said record. In an example the database is an on-line database. Such allows easy and relative cheap access to the database and the functionality thereof. Such is important, as many customers using the database will not be in a position to develop, maintain and pay for a similar database. By providing an on-line database, which inevitably can be shared by many users, costs are shared, and up to date functionality can be provided. As such users need not worry about the database and can concentrate on sing the functionality thereof, specifically in a track and trace system, such as HACCP. The record of the database is made available for entering data and/or reading data, such as described below.

Data typically relates to parameters and background data of a product. Examples are the name of a product, a location where the product is stored, such as in a fridge, freezer, warehouse, etc., a date of storage, a date of warning or removal, a date indicating end use date, storage temperature, instructions relating to storage conditions, such as the way a product should be or is packed, indication of risk of (cross-) contamination, relative humidity, company logo, (food) menu, company location, recipe, ingredients, remarks, certificate, date of production, etc. Typically one ore more of the foregoing parameters are used, as well as further parameters and information not mentioned. Further, room for a signature or the like may be available on the image.

In an example the application is directly accessible by providing an icon relating to the application.

In an example a menu for entering and/or reading data, such as product data, into and/or form the database is provided. Such a menu will guide a user when entering or retrieving data.

In an example according to the invention the on-line accessible database is accessible for a person or any person interested in product information, preferably through scanning the unique number, such as by scanning a barcode encoding the unique number, in particular wherein said number is part of an URL encoded in the barcode such as http://www.haccpdb.com/c.php?c=X, wherein X is the unique number. As such the person can use the information for track and trace purpose, such as the person that has entered the data or a control officer, but also the data can be used by consumers, that consume the product or use the product. Such makes the system fully transparent to an interested person.

In an example according to the invention the product information is directly accessible by communicating only the unique number to the database. By scanning a data matrix and/or a unique number a user may be directed to the database, which may be hosted on a website, and even further directly to the relevant, unique record. Thereby product information becomes accessible again.

In a sixth aspect the present invention relates to a use of an image according to the invention for controlling storage life and/or tracing food or food products for improving food safety and/or storage life, preferably in view of Salmonella enterica contamination, specifically Salmonella typhimurium, Salmonella enteritidis, Salmonella typhi and Salmonella paratyphi. Especially prevention of Salmonella infection of food products is an important aspect of the present invention.

In a seventh aspect the present invention relates to a system for addressing and/or retrieving information, said system comprising:
(i) a matrix barcode encoding a uniform resource locator (URL), said URL including the unique number of the invention;
(ii) an internet connectable device comprising at least a camera or scanner for reading the matrix barcode, such as a mobile phone;
(iii) matrix barcode reading software;
(iv) software for opening the URL;
(v) a plurality of information containing records, such as web pages, such as of an on-line database, wherein individual records, such as web pages, or group of records, such as groups of web pages, are reachable, preferably using the URL, wherein each record, such as a web page, or group of records, such as a group of web pages, are accessible, preferably via the URL, relate to a particular product and characteristics thereof (as identified above) identifiable by the unique number.

In an eighth aspect the present invention relates to a method for interrogating a database populated such as by the method of the invention, comprising: providing a device comprising means for scanning and transmitting, and loaded with an application for interfacing between a scanned image, the database and a user; scanning an image according to the invention with the device; transmitting the scanned image to a database using the device, preferably by wireless transmission, wherein the unique code of the image is linked to a record of the database, such as an on-line database, whereby the record of the database is made available for entering data and/or reading data; and optionally arranging the application to provide a menu for entering and/or reading data, such as product data, into and/or from the database, wherein optionally the database is accessible for a person who is interested in product information, preferably by scanning the unique number, and wherein optionally the product information is directly accessible by communication of the unique number to the database.

In a ninth aspect the present invention relates to an application loaded on a mobile device for interfacing between a scanned image, the database and a user, wherein the application: interprets a scanned image, wherein the image is the image of the invention, to determine at least the unique number of the image; arranges the mobile device to communicate the unique number of the image to a database; arranges the mobile device to receive and/or access one or more records of the database; and arranges the mobile device to output product and/or process information to a user.

In a tenth aspect the present invention relates to a track and trace system for HACCP comprising: the printed image of the invention; a database, preferably an on-line database such as a cloud database; and a device comprising means for scanning and transmitting, and loaded with an application for interfacing between a scanned image, a database and a user, and preferably provided with means, such as a menu for entering information for updating the database. Advantages of the above use are described in detail above.

### EXAMPLES

The invention shall now be detailed on the basis of an embodiment shown in the figures.

### BRIEF DESCRIPTION OF THE SEVERAL VIEWS OF THE DRAWINGS

FIG. 1 relates to state of the art labels for food products.

FIG. 2 relates to present labels.

FIGS. 3a-j relate to embodiments of the invention.

### DETAILED DESCRIPTION OF THE DRAWINGS/FIGURES

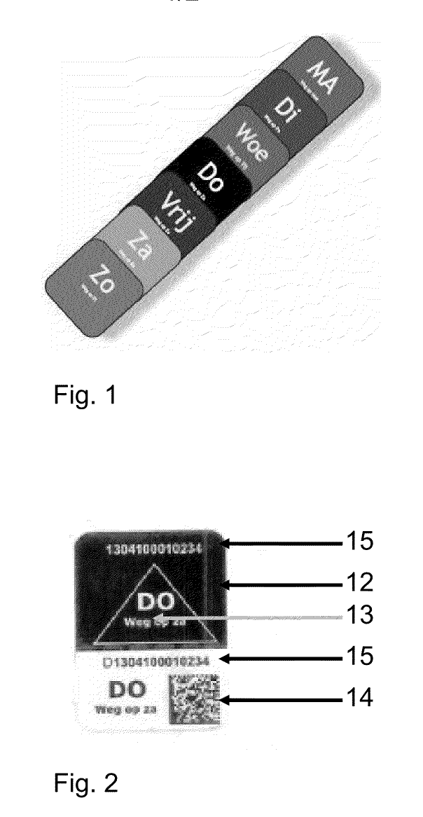

In FIG. 1 seven prior art labels are shown, one for each day. The prior art labels may also indicate when a product should be removed.

In FIG. 2 labels according to the present invention are shown. Therein a unique and single number (15) is shown. Within the present application the unique and single number is meant to comprise a combination of numbers and/or characters, such as alphanumeric characters, hexadecimal numbers, Latin characters, Greek characters, Arabic characters, Cyrillic characters, Chinese characters, Japanese characters etc. Further a day of the week indication (13) is given, wherein further a removal day is indicated. Also a data matrix (14) is provided. The label comprises a first top part (12) and a second bottom part.

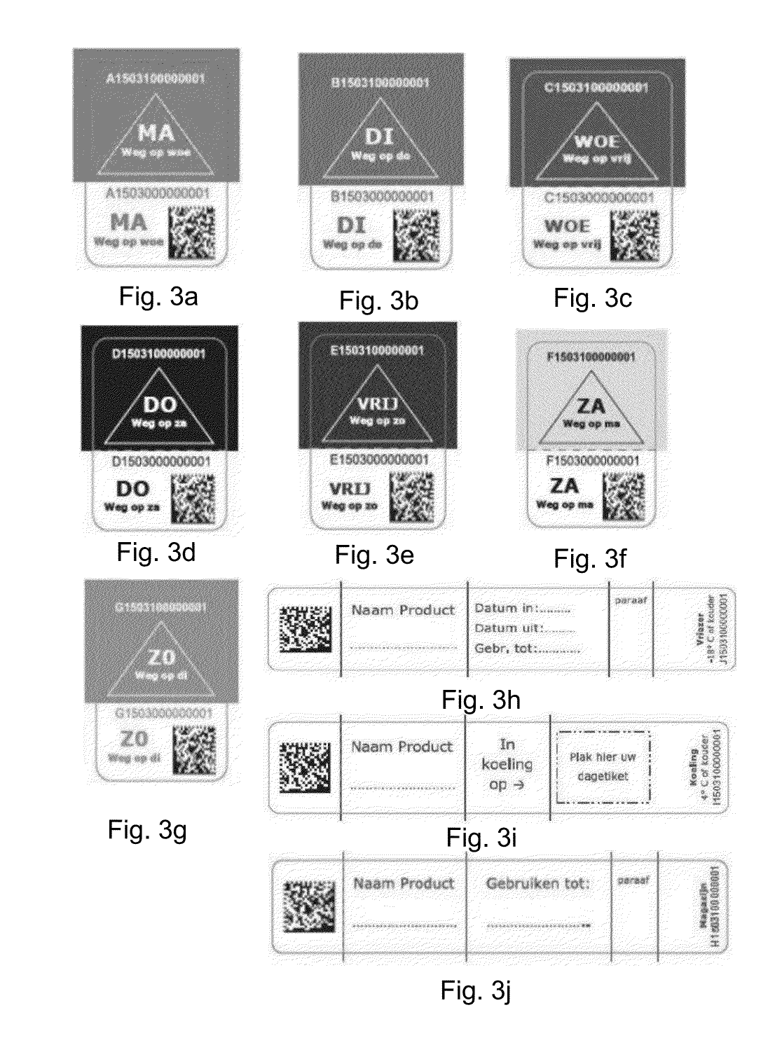

In FIG. 3 examples of present labels are shown. FIGS. 3a-g relate to a label for every day of the week, Figures h-j to a label for use in a fridge, a freezer and for storage.

What is claimed is:

1. Detachable printed image for track and trace purpose of a product, suitable for HACCP, comprising a first and a second part, wherein the first and second part both have the same single unique number for single use, preferably an alpha numeric number,
wherein the first and second part are separable from each other, wherein optionally the first and or second part comprise(s) one or more of a color code, a figure, a first text item, and a second text item, for recording product information and preferably also a production day, and/or
wherein optionally a tear line is provided between the first and second part.

2. An image according to claim 1, wherein the first and/or second part comprise(s) one or more of an optical code, a bar code, a data matrix, by preference a data matrix.

3. An image according to claim 1, wherein the image comprises an adhesive for attaching the image to the product, preferably an adhesive which is water soluble, more preferably water soluble at elevated temperature, such as at a temperature of 35° C.-90° C.

4. A reel comprising a plurality of images according to claim 1, wherein the unique number of the images is numbered consecutive.

5. A box, comprising the reel according to claim 4, wherein the reel is provided in a container.

6. A method for track and trace, comprising the steps of:
a. attaching a first part of an image according to claim 1 on a product,
b. optionally attaching a second part of an image according to claim 1 in a logbook,
c. recording product information, and
d. combining product information and unique number, wherein the product is preferably a food product.

7. A method according to claim 6, wherein the product information and unique number are entered in a database, preferably an online accessible database (clouding).

8. A method according to claim 6, wherein the unique number is optically scanned, preferably by a camera in a mobile telephone, preferably an IPHONE® 4.1 mobile telephone and higher.

9. A method according to claim 6, wherein the product information is entered into the database using a menu, preferably using one of Apple® software for IPHONE® 4.1, Android® software, and Microsoft® 7.0 and higher software.

10. A method according to claim 6, wherein product information is coupled to process information of the product.

11. A method according to claim 6, wherein an alert or warning is provided in case storage life of a food product has ended or is near to the end thereof.

12. A method for interrogating a database populated such as by a method according to claim 6 comprising:
providing a device comprising means for scanning and transmitting, and loaded with an application for interfacing between a scanned image, the database and a user,
scanning an image according to the invention with the device,
transmitting said scanned image to a database using the device, preferably by wireless transmission,
wherein the unique code of the image is linked to a record of the database, such as an on-line database, whereby the record of the database is made available for entering data and/or reading data, and
optionally arranging the application to provide a menu for entering and/or reading data, such as product data, into and/or from the database,
wherein optionally the database is accessible for a person who is interested in product information, preferably by scanning the unique number, and
wherein optionally the product information is directly accessible by communication of the unique number to the database.

13. An application loaded on a mobile device for interfacing between a scanned image, the database and a user, wherein the application:
interprets a scanned image, wherein the image is the image of claim 1, to determine at least the unique number of the image;
arranges the mobile device to communicate the unique number of the image to a database;
arranges the mobile device to receive and/or access one or more records of the database; and
arranges the mobile device to output product and/or process information to a user.

14. A track and trace system for HACCP comprising:
a printed image according to claim 1,
a database, preferably an on-line database such as a cloud database, and
a device comprising means for scanning and transmitting, and loaded with an application for interfacing between a scanned image, a database and a user, and preferably provided with means, such as a menu for entering information for updating the database.

15. Use of an image according to claim 1 for controlling storage life and/or tracing food or food products for improving food safety and/or storage life, preferably in view of Salmonella enterica contamination, specifically Salmonella typhimurium, Salmonella enteritidis, Salmonella typhi and Salmonella paratyphi.
